(19) United States
(12) Patent Application Publication
(10) Pub. No.: US 2004/0114581 A1
(43) Pub. Date: Jun. 17, 2004

(54) Voice-over-IP communicator

(76) Inventors: Mathieu Claude Hans, Athens, GA (US); Mark Taylor Smith, San Mateo, CA (US)

Correspondence Address: HEWLETT-PACKARD COMPANY, Intellectual Property Administration, P.O. Box 272400, Fort Collins, CO, 80527-2400, US

(21) Appl. No.: 10/319,988

(22) Filed: Dec. 16, 2002

(51) Int. Cl. H04L 12/66

(52) U.S. Cl. 370/356; 370/401; 370/402

(57) ABSTRACT

An exemplary apparatus for providing VoIP services comprises: (a) a telephone hardware interface connectable to a POTS network; (b) a VoIP gateway connectable to a VoIP network; (c) a bridge operable to interconnect a POTS session over the telephone hardware interface with a VoIP session over the VoIP gateway; and (d) an input/output interface that is connected to at least one of the telephone hardware interface, the VoIP gateway, and the bridge, and which is also connectable to a telephone.

### BACKGROUND

Voice-over-IP (VoIP) has become increasingly popular because it is a much more cost effective way to transmit and receive data than the conventional implementation of circuit switching over the plain old telephone system (POTS). Circuit switching is the foundation of the so-called public switched telephone network (PSTN). In a circuit switching network, when a call is made between two parties, a connection (or a circuit) is established and maintained for the entire duration of the call. The nature of such a dedicated circuit means that the resources cannot be shared by other callers, but are instead allocated exclusively to one particular transmitter and receiver.

VoIP is a technology that allows placement of telephone calls over the Internet. VoIP uses packet switching techniques for transmitting data, whereby the data are divided into small packets that are transmitted over the network. Each small packet typically includes an address telling the network the packet's destination. At the destination, a receiving device aggregates the packets and reassembles them into the original data (e.g., speech). For telephones to communicate with each other and with other devices (such as computers) over a data network, all the devices need to speak a common language, for example, by conforming to a protocol. There are currently two major protocols being used for VoIP, namely, the H.323 protocol and the SIP protocol. The protocols may define ways for devices to connect to each other using VoIP and may include specifications for audio codecs. A codec, which stands for coder-decoder, converts (or encodes) an audio signal into a compressed digital form for transmission, then converts (or decodes) the compressed signal back into an uncompressed audio signal for replay.

Typically, when using VoIP via a personal computer (PC), a user needs to equip the PC with audio input and output interfaces (e.g., headphone and/or a microphone and speakers, etc.). Some companies provide VoIP-enabled PC cards (e.g., Linejack PC card from Quicknet Technologies) that allow an analog phone to be used with a PC. In this case, the analog phone is generally physically plugged into the PC via the VoIP-enabled PC card. However, this type of arrangement still requires the use of a PC for VoIP; thus, VoIP is not possible in locations without a PC (e.g., bedroom, bathroom, garage, etc.).

Some commercially available adapters may allow VoIP via an analog phone without a PC. For example, Cisco's ATA 186 adapter has a processor configured to perform the functions that would otherwise be performed by the VoIP software running on a general purpose computer. However, the Cisco adapter does not allow the phone to be used both as a VoIP phone and a regular POTS phone. Thus, if a user wishes to receive or make calls via the PSTN, the user needs to physically unplug the analog phone from the Cisco adapter and plug the phone into a wall jack connected to the telephone central office.

Thus, a market exists for a VoIP communicator that allows VoIP as well as PSTN capabilities.

### SUMMARY

Various exemplary technologies are presented for providing VoIP services, and for joining a VoIP session and a POTS session.

An exemplary apparatus for providing VoIP services comprises: (a) a telephone hardware interface connectable to a POTS network; (b) a VoIP gateway connectable to a VoIP network; (c) a bridge operable to interconnect a POTS session over the telephone hardware interface with a VoIP session over the VoIP gateway; and (d) an input/output interface that is connected to at least one of the telephone hardware interface, the VoIP gateway, and the bridge, and which is also connectable to a telephone.

An exemplary method for providing VoIP services comprises connecting a telephone hardware interface to a POTS network, connecting a VoIP gateway to a VoIP network, and interconnecting a POTS session over the telephone hardware interface with a VoIP session over the VoIP gateway.

Other exemplary alternative embodiments and aspects are also disclosed.

### BRIEF DESCRIPTION OF THE FIGURES

FIG. 1 illustrates a block diagram of an exemplary VoIP communicator.

FIG. 2 illustrates a block diagram of an exemplary VoIP gateway within a VoIP communicator.

FIG. 3 illustrates a block diagram of an exemplary bridge within a VoIP communicator.

FIG. 4 illustrates an exemplary process for interconnecting a POTS network and VoIP network.

FIG. 5 illustrates an exemplary process for joining a VoIP session and a POTS session.

### DETAILED DESCRIPTION

I. Overview

A VoIP communicator that enables a telephone to be used as both a VoIP and a POTS phone is described. More specifically, Section II describes an exemplary VoIP communicator, Section III describes an exemplary VoIP gateway within a VoIP communicator, Section IV describes an exemplary bridge within a VoIP communicator, Section V describes an exemplary process for joining a VoIP session and a POTS session using a VoIP communicator, Section VI describes other exemplary aspects of the communicator, and Section VII describes an exemplary operating environment for a VoIP communicator.

II. An Exemplary VoIP Communicator

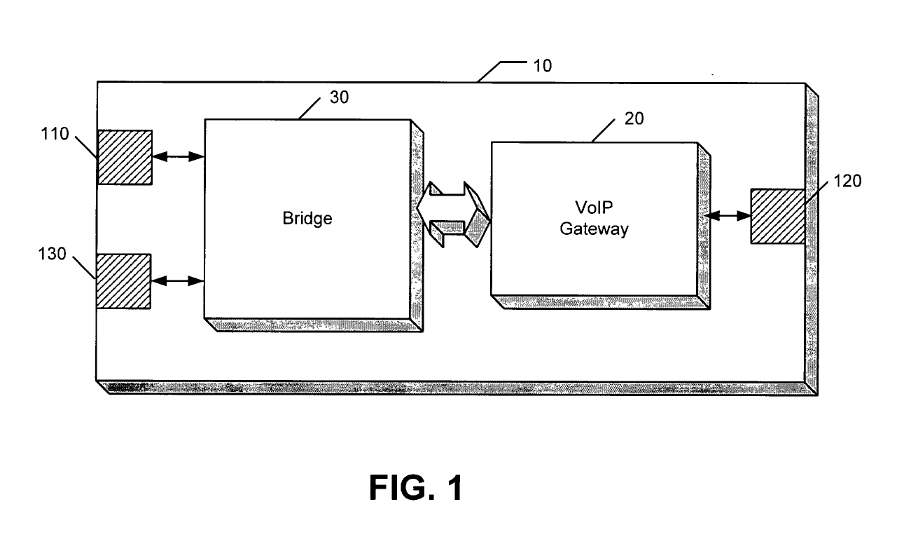

FIG. 1 illustrates an exemplary VoIP communicator 10. In an exemplary embodiment, the VoIP communicator 10 is connectable to both the POTS and VoIP networks via one or more interfaces on the communicator 10. For example, the VoIP communicator 10 may be connected to both the POTS and VoIP networks via a single hardware telephone interface 110 (e.g., a phone jack). In this example, the VoIP network connection may be provided via DSL operating over the POTS. Alternatively, the VoIP communicator 10 may be connected to the VoIP network via a wireless modem (not shown) internal or external to the communicator 10. Wireless connection techniques are well known in the art and need not be described in more detail herein. In yet another example, the VoIP communicator 10 may be connected to the POTS and VoIP networks via separate hardware interfaces 110, 120 (e.g., a RJ-45 interface 120 for the VoIP network and a RJ-11 interface 110 for the POTS network). In this example, the VoIP communicator 10 may include additional well-known technologies for connection to the VoIP network via Ethernet, cable, high speed modem (e.g., 56 K or higher), and/or other known techniques.

The VoIP communicator 10 is also connectable to a telephone which provides audio input/output functions. In an exemplary implementation, the telephone is connected via an audio I/O interface 130. The term “telephone” as used herein includes analog phones, digital phones, headsets, microphones and earphones, and/or other digital audio devices with audio I/O capabilities (e.g., personal digital assistants such as the HP Ipaq, etc.).

In one implementation, the VoIP communicator 10 is configured to implement the Session Initiation Protocol (SIP), and is registered at one or more SIP servers accessible via the VoIP network. SIP is a signaling protocol for network conferencing, telephony, presence, events notification and instant messaging. See, for example, information at http://www.sipforum.org/. Technology for implementing the SIP standard is commercially available and well known in the art. Thus, the foregoing need not be described in detail herein. Of course, the VoIP communicator 10 may also be configured to implement other protocols (e.g., H.323) in accordance with the specific requirements of a particular implementation.

Both SIP and H.323 define mechanisms for call routing, call signaling, capabilities exchange, media control, and supplementary services. For ease of explanation, exemplary embodiments and implementations in this application are described by reference to the SIP protocol. One skill in the art will readily appreciate that the various exemplary embodiments and implementations are adaptable/applicable to the H.323 protocol, a combination of these protocols (i.e., SIP and H.323), and/or other VoIP protocols under development or to be developed in the future.

Typically, when the VoIP communicator 10 is physically or wirelessly connected to the VoIP network, the VoIP communicator 10 indicates its presence to a primary/personal SIP server via the VoIP network. This is a common SIP protocol complied with by SIP-enabled devices so that SIP devices may communicate with each other via the SIP server.

In an exemplary embodiment, the VoIP communicator 10 also includes a VoIP gateway 20 and a bridge 30. Exemplary embodiments of these components will be described in more detail in Sections III and IV below.

III. An Exemplary VoIP Gateway

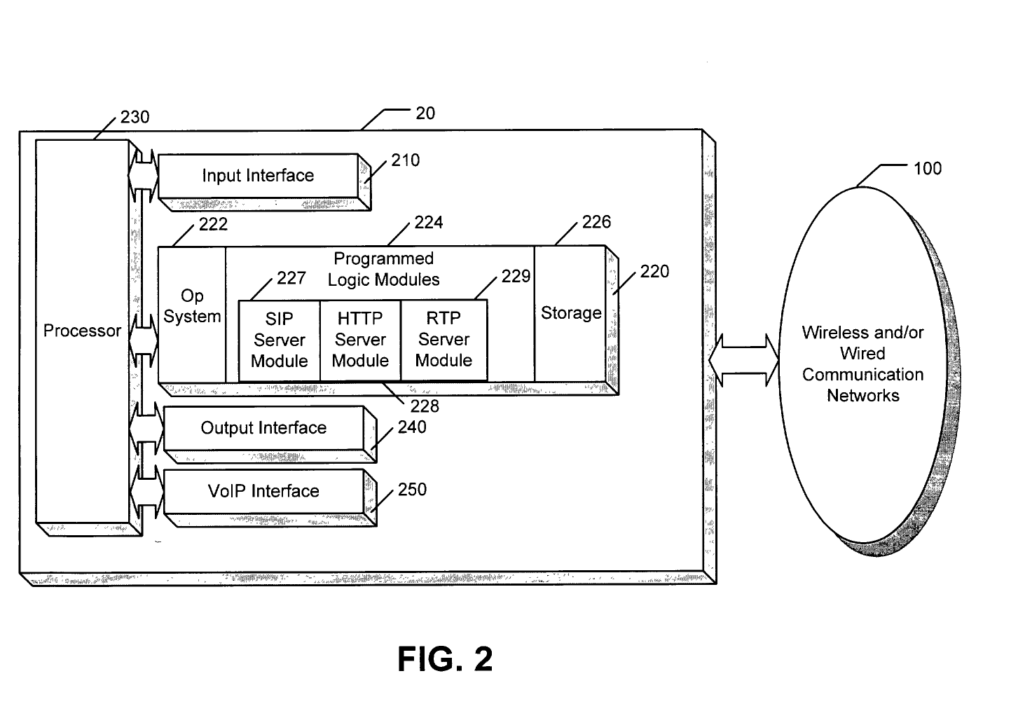

FIG. 2 illustrates an exemplary VoIP gateway 20. The description of FIG. 2 is intended to provide a general description of a common type of VoIP gateway in conjunction with which the various exemplary embodiments described herein may be implemented. Of course, other types of VoIP gateway may be used as well. Further, various embodiments described herein may also be practiced in a distributed computing environment where tasks are performed by remote processing devices that are linked through a communications network such as the wireless and/or wired communication networks 100. For example, in a distributed computing environment, program modules may be located in local and/or remote devices. Generally, the terms program, code, module, software, and other related terms as used herein may include routines, programs, objects, components, data structures, etc., that perform particular tasks or implement particular abstract data types.

In FIG. 2, the exemplary VoIP gateway 20 includes an input interface 210, a computer-readable memory 220, a processor 230, an output interface 240, and a VoIP interface 250.

A user may input control and/or information into the VoIP gateway 20 via an input device connected through the input interface 210. Input devices include, without limitation, a keyboard, a pointing device (e.g., pen, mouse, scroll pad, etc.), buttons/knobs, a joystick, a game pad, a touch screen, a jog dial, an optical sensor and/or other devices known to those skilled in the art. For example, a more sophisticated input device might allow inputs to be received via an XML enabled touch screen and/or an optical sensor that senses hand and/or body movements.

In an exemplary implementation, the input interface 210 is a serial port interface connected to the processor 230 that allows input device(s) to be physically coupled to the VoIP gateway 20. For example, an input device may comprise a separate add-on module that is connectable to the VoIP gateway 20 via the serial port interface. Alternatively, the input interface may be implemented as a parallel port, game port, a universal serial bus (USB), and/or implemented partially or entirely in software. For example, the input device may already be a part of the hardware structure of the VoIP gateway 20, and the input interface 210 may be implemented at least partially in software controlling the data flow between the input interface 210 and the rest of the VoIP gateway 20. The input interface 210, whether implemented in hardware or software or a combination thereof, is configurable to receive and transmit digital audio content and/or multimedia data via the communication networks 100.

The computer-readable memory 220 may include any combination of read-only memory (ROM), random access memory (RAM) of all types, a hard disk, a CD, and/or still other electronic, magnetic and/or optical media known to those skilled in the art. In an exemplary embodiment, the computer-readable memory 220 includes an operating system 222, programmed logic modules 224, and storage 226.

The operating system 222 may be implemented by operating systems known in the art, such as Linux, Ecos, Inferno, etc.

In an exemplary implementation, the programmed logic modules 224 include a SIP server module 227, a HTTP (Hypertext Transfer Protocol) server module 228, and a RTP (Real-Time Transport Protocol) server module 229 with codec support. In other exemplary implementations, the programmed logic modules 224 may include other modules (not shown) as appropriate. For example, the programmed logic module 224 may include a recording module (not shown) for recording communication sessions (described in more detail in Section VI below).

The SIP server module 227 is configurable to provide server services in accordance with the SIP protocol. The HTTP server module 228 is configurable to provide standard HTTP services and control of the communicator 10. The RTP server module 229 is configurable to provide real time digital content streaming and codec/encryption support. Technology for implementing these programmed modules is commercially available and known in the art and need not be described in more detail herein.

The processor 230 is configured to execute instructions in the programmed logic modules 224. The processor 230 is also configured to facilitate control among the components in the VoIP gateway 20, as appropriate.

The output interface 240 connects an output device, such as a monitor, a projector, speakers, and/or other types of display or audio output devices, to the VoIP gateway 20. In an exemplary embodiment, the output interface (and/or device) may be the same or different than the input interface (and/or device). For example, a GUI displayed on a monitor may be used to input commands and view displayed outputs.

The VoIP interface 250 provides a connection to the communication network 100 (i.e., the VoIP network). In an exemplary implementation, the VoIP interface 250 may be implemented in software or hardware or a combination thereof. For example, the VoIP interface 250 may include a physical plug or jack (e.g., interface 120) suitable for connecting to the VoIP network via cable, Ethernet, etc. In another exemplary implementation, the VoIP interface 250 may provide connection to an internal or external wireless modem that allows the VoIP gateway 20 to be wirelessly connected to the VoIP network.

It is to be understood that the above described and/or other components of a VoIP gateway 20 need not reside in a single device. These components may be distributed among multiple computing devices (e.g., a personal computer, a PDA, a cell phone, etc.) operating in a distributed computing environment in accordance with a particular implementation.

Also, some or all of the programmed logic modules 224 may be implemented in hardware, perhaps even eliminating the need for a separate processor 230, if the hardware modules themselves contain the requitsite processor functionality.

The VoIP gateway 20 provides digital control of the bridge 30 via the processor 230 and is connected to PSTN via the bridge 30.

IV. An Exemplary Bridge

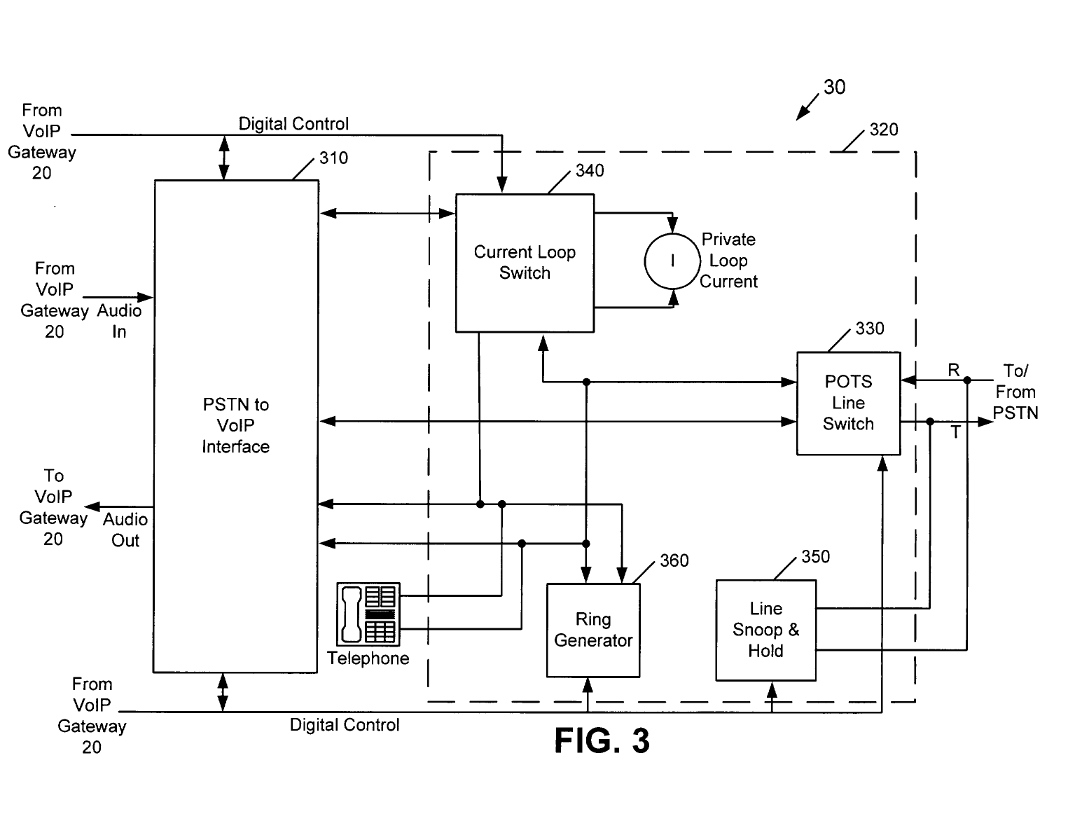

FIG. 3 illustrates an exemplary bridge 30. The bridge 30 includes a PSTN to VoIP interface 310 and a POTS interface 320. The description of FIG. 3 is intended to provide a general description of a type of bridge in conjunction with which the various exemplary embodiments described herein may be implemented. Of course, other types of bridge may be used as well. Further, various embodiments described herein may also be practiced in a distributed computing environment where tasks are performed by remote processing devices that are linked through a communications network, such as the wireless and/or wired communication networks 100.

A. PSTN to VoIP Interface

In an exemplary implementation, the PSTN to VoIP interface 310 includes circuitry that allows audio content from a networked device to be applied to the PSTN via the VoIP gateway 20 and vice versa. In an exemplary embodiment, the PSTN to VoIP interface 310 provides various functions including: (1) FCC-approved way(s) to connect to the PSTN (e.g., line isolation capability); (2) line control (e.g., going off hook, ring detection, sending dual tone multi-frequency (DTMF) tones to dial, and/or receiving/decoding DTMF tones, etc.); and (3) line hybrid functions (e.g., separating audio input/output to the two wire phone line, etc.).

In an exemplary implementation, a commercially available PSTN to VoIP interface 310 (e.g., XECOM's XE0068DT Direct Access Arrangement (DAA) module) may be used in conjunction with the various exemplary embodiments described herein.

B. POTS Interface

The POTS interface 320 provides the PSTN to VoIP interface 310 with access to POTS calls. An exemplary POTS interface 320 includes a POTS line switch 330, a current loop switch 340, a line snoop and hold circuit 350, and a ring generator 360.

The POTS line switch 330 is normally closed so that in the event of a power failure, the telephone may still be used over the PSTN. In addition, when the POTS line switch is closed, a VoIP and a POTS call may be joined in a single communication session. When the POTS line switch 330 is open, the telephone can be used as a VoIP phone.

The current loop switch 340 enables current from one of two sources to be applied to the telephone and the PSTN to VoIP interface 310. For example, current comes from a private loop current source when the telephone is being used as a VoIP-enabled phone (i.e., when the POTS line switch 330 is open). When the POTS line switch 330 is closed, current typically comes from the telephone central office and the telephone may be used as a VoIP phone and a POTS phone at the same time.

The snoop and hold circuit 350 provides snoop functions and line hold control. In an exemplary implementation, the snoop and hold circuit 350 snoops the POTS line in order to inform the VoIP gateway 20 whether or not the POTS line is already in use. This way, the VoIP gateway 20 will not attempt to use the PSTN to VoIP interface 310 to connect to the POTS network if the POTS line is already in use. In another exemplary implementation, if a user is in a VoIP session, the snoop and hold circuit 350 may detect if the telephone central office is trying to ring the telephone over the POTS line. If so, the snoop and hold circuit 350 would activate the ring generator 360 (described below) to ring the telephone on behalf of the telephone central office.

The snoop and hold circuit 350 also provides line hold control that allows a user to temporarily and/or permanently disconnect any call (POTS or VoIP) from a session. The snoop and hold circuit 350 also provides other functions, such as callerID. Technology for implementation of the snoop and hold circuit 350 is well known and need not be described in more detail herein.

The ring generator 360 generates low frequency AC high voltage that is used to ring the telephone. In an exemplary implementation, the ring generator 360 is used when the telephone is functioning as a VoIP-enabled phone. When the telephone is being used as a POTS phone, then the telephone central office typically generates the ring voltage(s). The ring generator 360 may generate rings with different ring patterns and/or volumes, depending on the configuration. For example, the ring generator 360 may be configured to provide a different type of ring for calls from selected individuals and/or network(s) (i.e., POTS network or VoIP network).

Further, the ring generator 360 may be configured to ring even if the telephone is being used in a session (POTS, VoIP, or both). In an exemplary implementation, this mode may be accomplished by putting the line on hold (via the snoop and hold circuit 350) briefly and applying the ring voltage. This way, a user may then decide to answer the new call, refuse it, or join it into the current session. For example, when the communicator 10 is in a VoIP and POTS conference mode, any additional VoIP call may be added or disconnected at will by the user. For example, the communicator 10 may include a GUI that allows selection of additional callers on screen and/or via other input device. Alternatively, a GUI implemented via XML/HTTP on another device accessible by the communicator 10 (e.g., a PDA, a Swatch WebWatch, etc.) may be used. In another example, the telephone keypad may also be used. Technology for implementation of the ring generator 360 is well known and need not be described in more detail herein.

Some types of telephone may not be sophisticated enough to ring while the telephone is being used in a session. In an exemplary embodiment, an auxiliary ringer (not shown) may be implemented as part of the ring generator 360 to provide rings to indicate that another call is coming in (and other functions of complementing the ring generator 360). In this implementation, the auxiliary ringer may include a circuit controlled by a switch accessible by a user such that the user may turn on the auxiliary ringer as needed. Alternatively, the auxiliary ringer may be turned on automatically by the ring generator 360 as needed. The auxiliary ringer may be implemented to provide voice generation instead of and/or in addition to providing rings. Technology for implementation of an auxiliary ringer is well known and need not be described in more detail herein.

The bridge 30 described above is merely exemplary. Those skilled in the art will appreciate that still other implementations may be used. For example, the bridge 30 may include a hybrid USB/audio device (e.g., in the PSTN to VoIP interface 310) that is attachable to one or more devices with an audio card and a USB host port (e.g., a laptop computer, a PDA, etc.). In this example, the audio I/O and/or the digital control to and from the VoIP gateway 20 may be provided via any combination of digital or analog audio interfaces, such as the USB port, DSL, Ethernet, firewire, etc.

V. An Exemplary Process for Joining a VoIP Session and a POTS Session

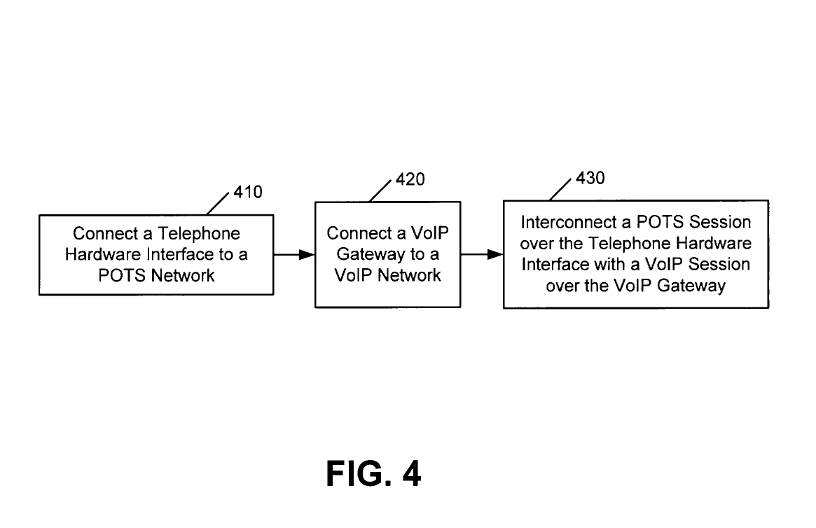

FIG. 4 illustrates an exemplary process for interconnecting a POTS network and a VoIP network. At step 410, the communicator 10 is connected to a POTS network via a telephone hardware interface (e.g., 110 of FIG. 1). At step 420, the communicator 10 is also connected to a VoIP network via a VoIP gateway (e.g., 20 of FIG. 1). Next, at step 430, a POTS session initiated by a user via the communicator 10 may be interconnected to a VoIP session via the telephone hardware interface and the VoIP gateway, respectively.

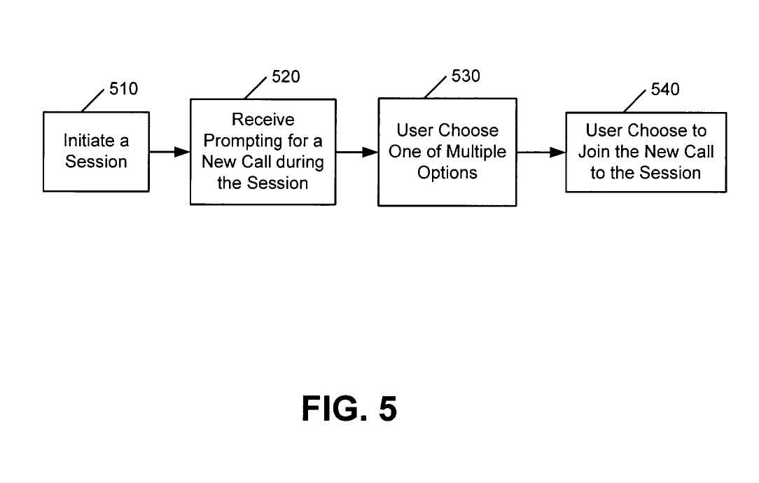

FIG. 5 illustrates an exemplary process for joining a VoIP session and a POTS session. At step 510, a communication session is initiated by the communicator 10. For example, the session may be initiated by making or answering a VoIP call or a POTS call. During the VoIP or POTS session, at step 520, the user may be prompted by an audio input/output device (e.g., a telephone) for a new call. For example, the audio input/output device may provide different rings (e.g., differences in volume, type of rings, ring repetition, etc.) to indicate whether the new call was from a VoIP network or POTS network. At step 530, the user then has a number of choices. For example, the user may decide to answer and join the new call to the current session, refuse the new call, terminate the old call and answer the new call to begin a new session, etc. At step 540, if the user decides to answer and join the new call to the current session, the user then may indicate a selection via an input device. For example, the user may make the selection on a GUI, punch in a code in a telephone keypad, push a soft button on the communicator 10, etc.

The processes described above are merely exemplary. One skilled in the art will readily appreciate that other types of sessions may be joined as well. For example, multiple VoIP sessions and/or other conferencing combinations (e.g., multiple VoIP sessions and a POTS session) may be joined.

VI. Other Exemplary Aspects

In an exemplary implementation, the communicator 10 may also facilitate the recording of a session. In this implementation, the VoIP gateway 20 may include a recording module (not shown) for recording sessions. The communicator 10 may stream a communication session in a secure manner (e.g., encrypted) to its primary/personal SIP server (somewhere on the VoIP network) to store or further process the recording. For example, the primary SIP server may decode (e.g., decrypt) the recording then index the recording by time, date, key words, and/or other processing techniques so that the recording can be easily accessed in the future (e.g., searched, browsed, archived, visualized, etc.). Alternatively, a recording module may be included as a sub-module of the communicator 10 with indexing capabilities. The recording feature may be configured to be the default feature or may be manually selected each time a session is initiated. For example, the user may be prompted via a GUI to select whether to record a session.

In another exemplary implementation, multimedia data may be transferred during a session. For example, during a VoIP session where two parties are having a conversation over the VoIP network, party one may wish to send a picture to party two. In this case, party one can send the picture directly to the communicator 10 at party two via the VoIP network. Upon receipt of the picture, the communicator 10 may automatically search for a nearby display device. In one embodiment, the communicator may itself be equipped and/or connected to a display device (e.g., a monitor, a projector, etc.) via the output interface 240. In another embodiment, the communicator may not be equipped and/or connected to a display device (or it may otherwise wish not to use its own display device). In this case, the communicator 10 may send a request to its primary SIP server for a nearby display device. The SIP server may return with the location and availability of a number of devices and the communicator 10 then may select the device it wishes to use as a display device and display the picture. If the communication session involving multimedia data is recorded, the multimedia data may also be stored along with the audio representation of the session.

The processes described above are merely exemplary, and their corresponding examples are merely illustrative. Those skilled in the art will appreciate that still other uses of the communicator 10 may be implemented.

VII. Operating Environment

The embodiments described herein may be implemented in an operating environment comprising software installed on a computer, in hardware, or in a combination of software and hardware.

The software and/or hardware would typically include some type of computer-readable media which can store data and logic instructions (such as those which, when executed, is capable of joining a VoIP session and a POTS session) that are accessible by the computer or the processing logic within the hardware. Such media might include, without limitation, hard disks, floppy disks, magnetic cassettes, flash memory cards, digital video disks, Bernoulli cartridges, random access memories (RAMs), read only memories (ROMs), and the like.

### VIII. CONCLUSION

The foregoing examples illustrate certain exemplary embodiments from which other embodiments, variations, and modifications will be apparent to those skilled in the art. The inventions should therefore not be limited to the particular embodiments discussed above, but rather are defined by the claims.

What is claimed is:

1. An apparatus for providing VoIP services, comprising:
(a) a telephone hardware interface connectable to a POTS network;
(b) a VoIP gateway connectable to a VoIP network;
(c) a bridge operable to interconnect a POTS session over said telephone hardware interface with a VoIP session over said VoIP gateway; and
(d) an input/output interface:
(1) connected to at least one of said telephone hardware interface, said VoIP gateway, and said bridge; and
(2) connectable to a telephone.

2. The apparatus of claim 1 where said VoIP network is implemented over said POTS network.

3. The apparatus of claim 2 where said VoIP gateway connects to said VoIP network via said telephone hardware interface.

4. The apparatus of claim 1 where said VoIP network is different from said POTS network.

5. The apparatus of claim 1 where said VoIP gateway includes a high speed modem.

6. The apparatus of claim 1 where said VoIP gateway is connectable to a high speed modem situated between said VoIP gateway and said VoIP network.

7. The apparatus of claim 1 where said bridge includes:
(1) a PSTN to VoIP interface; and
(2) a POTS interface.

8. The apparatus of claim 7 where said bridge includes a ring generator.

9. The apparatus of claim 7 where said bridge includes a current generator configured to generate current in response to VoIP services.

10. The apparatus of claim 7 where said bridge includes a snoop and hold circuit.

11. The apparatus of claim 1 where said VoIP gateway is capable of joining multiple VoIP sessions.

12. The apparatus of claim 11 where said bridge is operable to join multiple VoIP sessions.

13. The apparatus of claim 12 where said input/output interface includes a graphic user interface for user control to join multiple VoIP sessions.

14. The apparatus of claim 1 where said bridge is operable to join VoIP and POTS sessions.

15. The apparatus of claim 1 where said VoIP gateway includes a recording module configured to record a session.

16. The apparatus of claim 15 where said recording module includes a sub-module configured to index said recorded session.

17. The apparatus of claim 1 further comprising an interface for outputting multimedia content received over at least one of said sessions.

18. The apparatus of claim 1 where said bridge is configured to provide conference calling capability.

19. The apparatus of claim 1 where said bridge is configured to allow a user to pick up either a VoIP or a POTS call via said telephone.

20. A method for providing VoIP services, comprising:
(a) connecting a telephone hardware interface to a POTS network;
(b) connecting a VoIP gateway to a VoIP network; and
(c) interconnecting a POTS session over said telephone hardware interface with a VoIP session over said VoIP gateway.

21. The method of claim 20 further comprising:
(d) generating a distinctive ring on a telephone to indicate whether a call is from said POTS network or said VoIP network.

22. The method of claim 20 further comprising:
(d) generating a current in response to VoIP services.

23. The method of claim 20 further comprising:
(d) snooping said POTS network; and
(e) generating a distinctive ring on a telephone to indicate that an incoming call is from said POTS network.

24. The method of claim 20 further comprising:
(d) placing a session on hold; and
(e) generating a distinctive ring on a telephone during said session to indicate an incoming call.

25. The method of claim 20 further comprising:
(d) joining multiple VoIP sessions via said VoIP gateway.

26. The method of claim 20 further comprising:
(d) providing a graphic user interface; and
(e) receiving user control to join multiple VoIP sessions via said graphic user interface.

27. The method of claim 20 further comprising:
(d) recording a session.

28. The method of claim 27 further comprising:
(d) processing said recorded session.

29. The method of claim 28, where said processing includes:
(i) indexing said recorded session.

30. The method of claim 20 further comprising:
(d) receiving multimedia content over at least one of said sessions.

31. The method of claim 20 further comprising:
(d) providing conference calling capability.

32. The method of claim 20 further comprising:
(d) allowing a user to pick up either a VoIP or a POTS call via a telephone.

33. An apparatus for providing VoIP services, comprising:
(a) means for connecting to a POTS network;
(b) means for connecting to a VoIP network;
(c) means for interconnecting a POTS session with a VoIP session; and
(d) means for providing audio input/output.

34. The apparatus of claim 33 further comprising means for generating different rings.

35. The apparatus of claim 33 further comprising means for generating current in response to VoIP services.

36. The apparatus of claim 33 further comprising means for line snooping and holding.

37. The apparatus of claim 33 further comprising means for joining multiple VoIP sessions.

38. The apparatus of claim 33 further comprising means for recording a session.

39. The apparatus of claim 33 further comprising means for outputting multimedia content received over at least one of said sessions.

40. The apparatus of claim 33 further comprising means for where said bridge is providing conference calling capability.

41. The apparatus of claim 33 further comprising means for allowing a user to pick up either a VoIP or a POTS call via said telephone.

42. A computer readable medium for executing a computer method, comprising logic instructions that, if executed:
(a) connect a telephone interface to a POTS network;
(b) connect a VoIP gateway to a VoIP network; and
(c) interconnect a POTS session with a VoIP session over said VoIP gateway.

43. The computer readable medium of claim 42 further comprising logic instructions that, if executed:
(d) generate a distinctive ring on a telephone to indicate whether a call is from said POTS network or said VoIP network.

44. The computer readable medium of claim 42 further comprising logic instructions that, if executed:
(d) generate a current in response to VoIP services.

45. The computer readable medium of claim 42 further comprising logic instructions that, if executed:
(d) snoop said POTS network; and
(e) generate a distinctive ring on a telephone to indicate that an incoming call is from said POTS network.

46. The computer readable medium of claim 42 further comprising logic instructions that, if executed:
(d) join multiple VoIP sessions via said VoIP gateway.

47. The computer readable medium of claim 42 further comprising logic instructions that, if executed:
(d) record a session.

48. The computer readable medium of claim 42 further comprising logic instructions that, if executed:
(d) receive multimedia content over at least one of said sessions.

49. The computer readable medium of claim 42 further comprising logic instructions that, if executed:
(d) provide conference calling capability.

50. The computer readable medium of claim 42 further comprising logic instructions that, if executed:
(d) allow a user to pick up either a VoIP or a POTS call via a telephone.
